(19) United States
(12) Patent Application Publication
(10) Pub. No.: US 2008/0143872 A1
(43) Pub. Date: Jun. 19, 2008

(54) Electronic device having an image capturing device

(75) Inventors: Yao-Ju Lu, Taipei City (TW); Hsi-Yung Liu, Taipei City (TW); Chung-Nan Liu, Taipei City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Compal Communications, Inc., Taipei City (TW)

(21) Appl. No.: 12/001,607

(22) Filed: Dec. 10, 2007

(30) Foreign Application Priority Data
Dec. 15, 2006 (TW) 095147142

(51) Int. Cl. H04N 5/225

(52) U.S. Cl. 348/374; 348/E05.024

(57) ABSTRACT

An electronic device includes an image capturing device disposed on a housing and including a casing that is disposed partly in an inner receiving space in the housing and that is pivotable relative to the housing, an imaging lens mounted on the casing for generating an optical image of an object, an image sensing module disposed in the inner receiving space in the housing and adjacent to the casing for sensing the optical image generated by the imaging lens, and a reflector disposed in the case so as to reflect the optical image from the imaging lens toward the image sensing module such that the optical image is received by the image sensing module.

### CROSS-REFERENCES TO RELATED APPLICATIONS

This application claims priority to Taiwanese Application No. 095147142, filed Dec. 15, 2006, the disclosure of which is incorporated herein by reference.

### BACKGROUND OF THE INVENTION

1. Field of the Invention

The invention relates to an electronic device, more particularly to an electronic device having an image capturing device.

2. Description of the Related Art

FIGS. 1 and 2 illustrate a conventional mobile phone 6 that includes a housing 61, and an image capturing device 62 connected pivotally to the housing 61. The image capturing device 62 includes a casing 621 connected pivotally to the housing 61 by two pivot pins 622 that engage rotatably and respectively two pivot holes 611 in the housing 61, an imaging lens 631 mounted on the casing 621 for generating an optical image of an object, and an image sensing module (not shown) disposed in the casing 621, receiving the optical image from the imaging lens 631 and outputting an electrical signal corresponding to the optical image to a main board (not shown) disposed in the housing 61 via a flexible printed circuit board 63.

In such a configuration, the casing 621 can only pivot about a transverse axis (x) relative to the housing 61 within a limited angular range depending on the length of the flexible printed circuit board 63. Furthermore, when pivoting movement of the casing 621 about a longitudinal axis perpendicular to the transverse axis (x) is desired, a complex design and higher costs are required.

### SUMMARY OF THE INVENTION

Therefore, the object of the present invention is to provide an electronic device having an image capturing device that can overcome the aforesaid drawbacks of the prior art.

According to the present invention, an electronic device comprises:

a housing configured with an elongate inner receiving space extending in a longitudinal direction, and formed with a housing opening in spatial communication with the inner receiving space; and

an image capturing device disposed on the housing and including
a casing mounted partly in the inner receiving space in the housing and pivotable relative to the housing, the casing being formed with a first opening in spatial communication with the inner receiving space in the housing, and a second opening disposed outwardly of the housing,
an imaging lens mounted on the casing and covering the second opening in the casing, the imaging lens being adapted for generating an optical image of an object,
an image sensing module disposed in the inner receiving space in the housing and adjacent to the first opening in the casing for sensing the optical image generated by the imaging lens, and
a reflector disposed in the casing for reflecting the optical image from the imaging lens toward the image sensing module such that the optical image is received by the image sensing module.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic rear view of a conventional mobile phone;

FIG. 2 is a partly exploded, fragmentary perspective view of the conventional mobile phone;

FIG. 3 is a perspective view showing the preferred embodiment of an electronic device according to the present invention;

FIG. 4 is a partly exploded, fragmentary perspective view showing the preferred embodiment;

FIG. 5 is a fragmentary perspective view showing a housing of the preferred embodiment;

FIG. 6 is an exploded fragmentary perspective view showing an image capturing device of the preferred embodiment;

FIG. 7 is a fragmentary, schematic partly sectional front view showing the preferred embodiment when a casing is disposed at a retracted position;

FIG. 8 is a fragmentary, schematic partly sectional front view showing the preferred embodiment when the casing is disposed at an extended position;

FIG. 9 is a fragmentary schematic sectional side view showing the preferred embodiment when the casing is disposed at the extended position; and

FIG. 10 is a fragmentary schematic sectional top view illustrating engagement between two spring-loaded retainers and a C-shaped guiding groove in a housing of the preferred embodiment when the casing is disposed at the extended position.

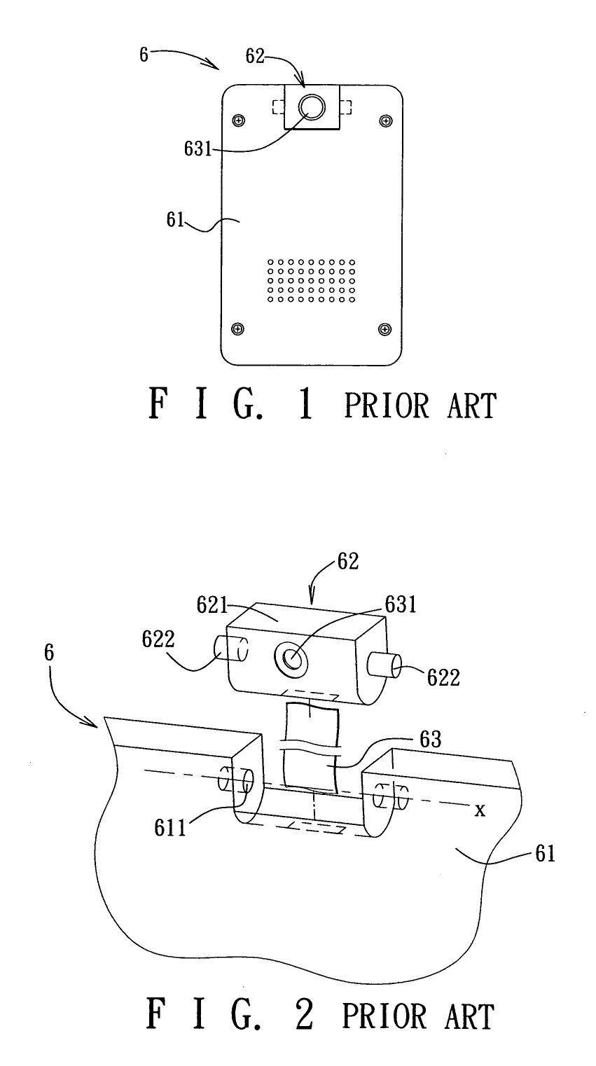

### DETAILED DESCRIPTION OF THE PREFERRED EMBODIMENT

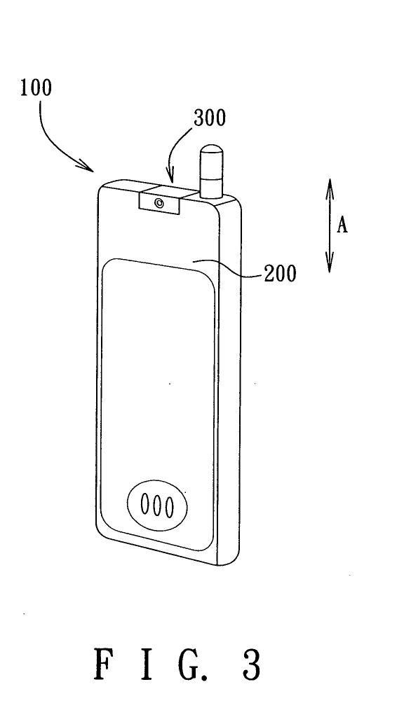

Referring to FIG. 3, the preferred embodiment of an electronic device 100 according to the present invention is shown to include a housing 200 and an image capturing device 300. In this embodiment, the electronic device 100 is a mobile phone, but is not limited thereto. In other embodiments, the electronic device can be a personal digital assistant or a notebook computer.

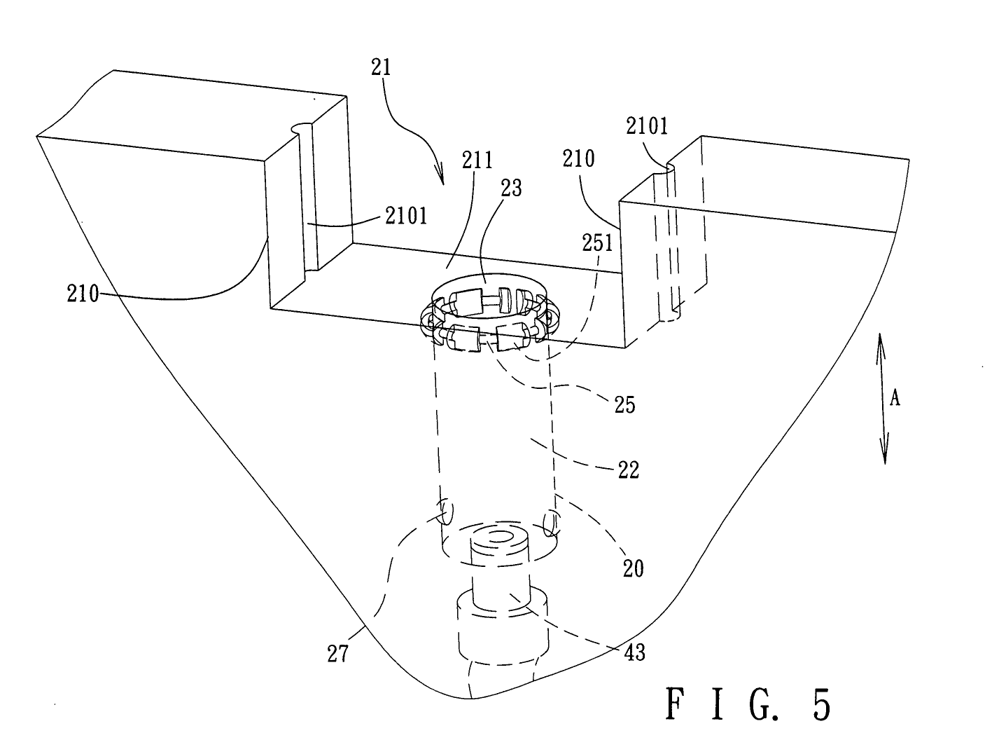

Referring further to FIG. 5, the housing 200 has a top side formed with a receiving groove 21 that is defined by opposite lateral walls 210, and a groove bottom wall 211 interconnecting ends of the lateral walls 210 and formed with a housing opening 23. The housing 200 is configured with an elongate inner receiving space 22 extending in a longitudinal direction (A) and in spatial communication with the receiving groove 21 through the housing opening 23. In this embodiment, each lateral wall 210 is formed with a guiding slot 2101 extending in the longitudinal direction (A). The inner receiving space 22 is defined by an annular inner surrounding wall 20 that is formed with a C-shaped guiding groove 25 disposed adjacent to the groove bottom wall 211, and opposite engaging grooves 27 distal from the groove bottom wall 211. The C-shaped guiding groove 25 has a plurality of enlarged groove portions 251 spaced apart from each other in a circumferential direction.

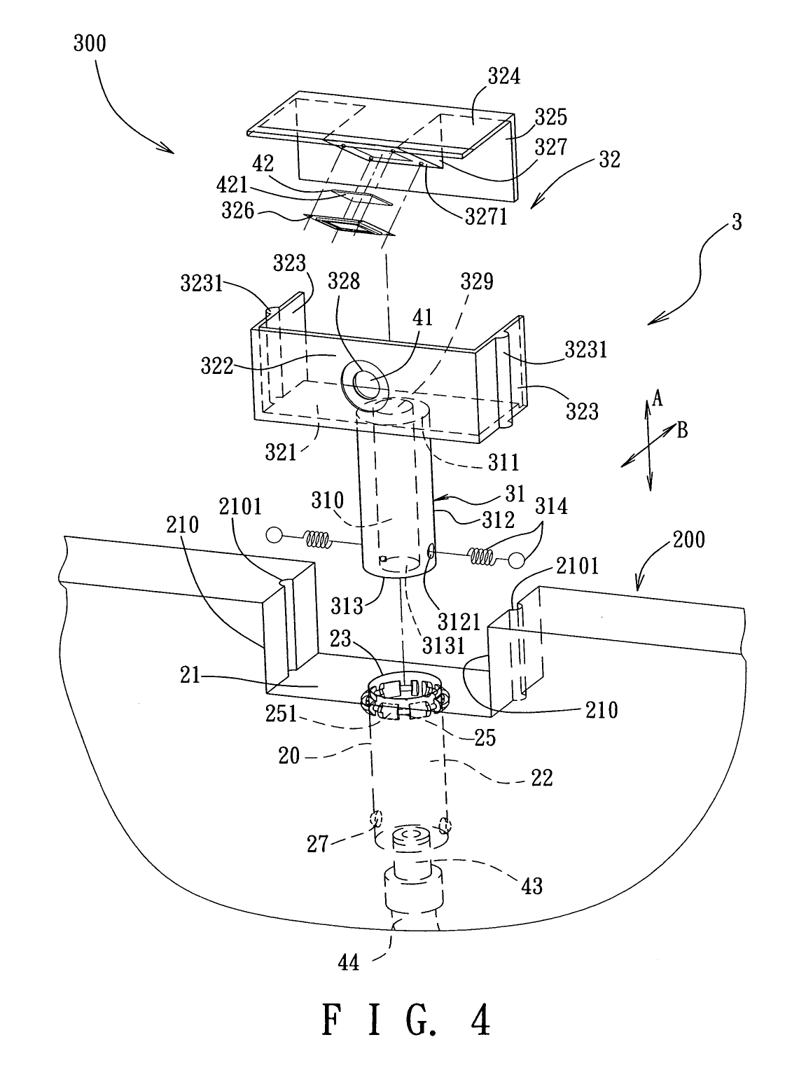

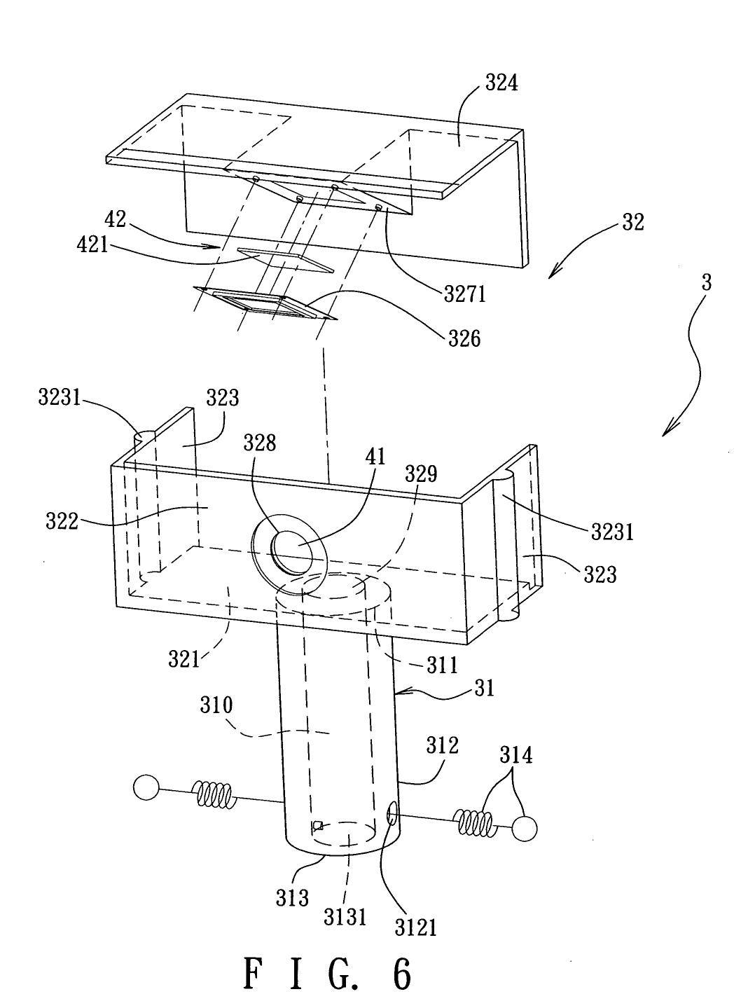

Referring further to FIGS. 4, 6, 7 and 9, the image capturing device 300 is disposed on the housing 200, and includes a casing 3, an imaging lens 41, an image sensing module 43, and a reflector 42.

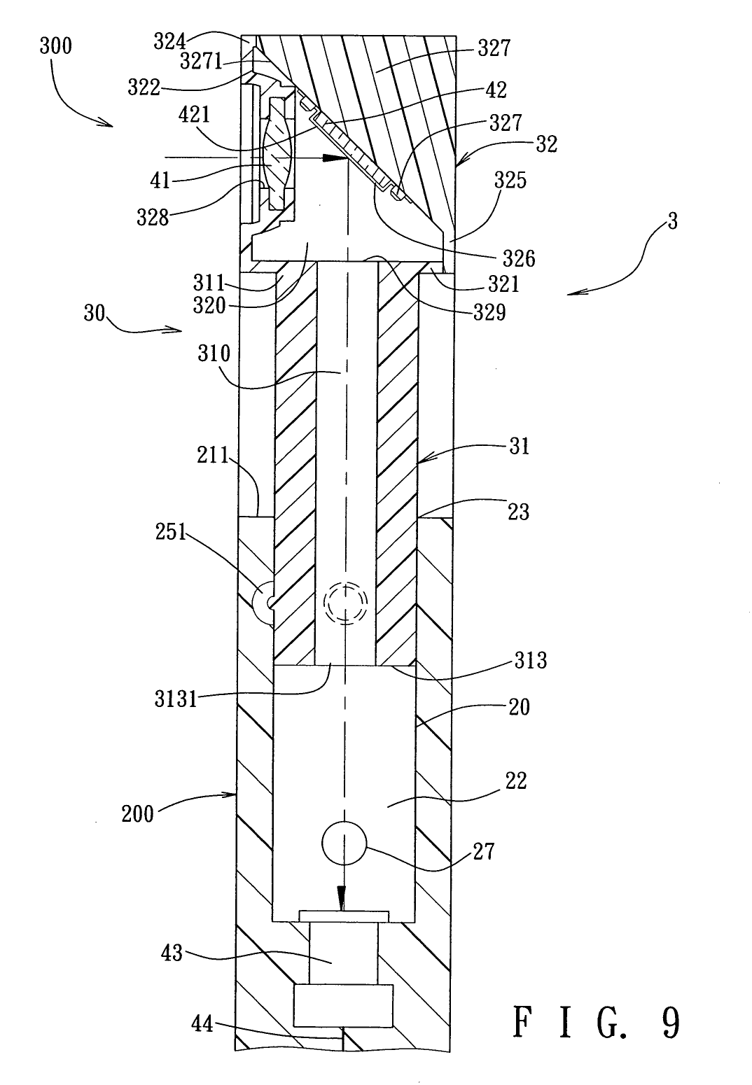

The casing 3 is disposed partly in the inner receiving space 22 in the housing 200, and is formed with a first opening 3131 in spatial communication with the inner receiving space 22, an a second opening 328 disposed outwardly of the housing 200. In this embodiment, the casing 3 has a sleeve body 31 and a case body 32. The sleeve body 31 is disposed fittingly and rotatably in the inner receiving space 22 in the housing 200, and is movable relative to the housing 200 in the longitudinal direction (A). The sleeve body 31 is configured with a first inner space 310, and has a lower end 313 formed with the first opening 3131. The sleeve body further has an annular outer surrounding surface 312 formed with opposite receiving grooves 3121, and two spring-loaded retainers 314 mounted retractably and respectively in the receiving grooves 3121 in the annular outer surrounding surface 312. The case body 32 is connected fixedly to an upper end 311 of the sleeve body 31, and is disposed outwardly of the housing 200. In this embodiment, the case body 32 is rectangular, and has a first side wall 321 connected integrally to the upper end 311 of the sleeve body 31 and formed with a third opening 329, a second side wall 322 connected to and perpendicular to the first side wall 321, and formed with the second opening 328, a third side wall 324 opposite to the first side wall 321 in the longitudinal direction (A) and connected to the second side wall 322, a fourth side wall 325 opposite to the second side wall 322 in a transverse direction (B) perpendicular to the longitudinal direction (A) and interconnecting the first and third sidewalls 321, 324, and opposite lateral end walls 323 interconnecting the first, second, third and fourth sidewalls 321, 322, 324, 325 and cooperating with the first, second, third and fourth side walls 321, 322, 324, 325 to define a second inner space 320 (see FIG. 9), wherein the second opening 328 in the second side wall 322 is in spatial communication with the second inner space 320 and wherein the second inner space 320 is in spatial communication with the first inner space 310 in the sleeve body 31 through the third opening 329 such that the first and second inner spaces 310, 320 define an image-relaying passage 30. The case body 32 further has a mounting block 327 that interconnects integrally the third and fourth side walls 324, 325 and that has an inclined mounting surface 3271. Each end wall 323 of the case body 32 is formed with an elongate engaging flange 3231.

The imaging lens 41, such as a convex lens, is mounted on the second side wall 322 of the case body 32 of the casing 3 by insert molding, and covers the second opening 328 in the second side wall 322. The imaging lens 41 is adapted for generating an optical image of an object, as best shown in FIG. 9.

The image sensing module 43, such as a charge-coupled device, is disposed in the inner receiving space 22 in the housing 200 and adjacent to the lower end 313 of the sleeve body 31 of the casing 3 for sensing the optical image generated by the imaging lens 31 so as to generate an electrical signal corresponding to the optical image. In this embodiment, the image sensing module 43 is connected to a main board (not shown) via a flexible printed circuit board 44.

The reflector 42 is disposed in the case body 32 of the casing 3, is mounted fixedly on the inclined mounting surface 3271 of the mounting block 327 using a mounting frame 326, and has an inclined reflecting surface 421 facing toward the second and third openings 328, 329 such that the optical image from the imaging lens 41 is reflected by the reflector 42 toward the image sensing module 43 through the image-relaying passage 30, as indicated by imaginary arrow lines of FIG. 9. Hence, the optical image is received by the image sensing module 43.

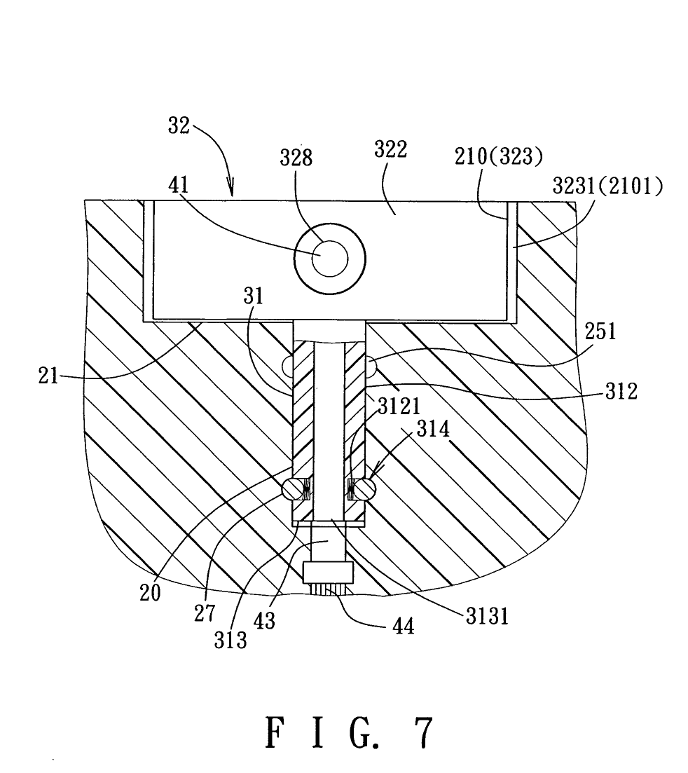

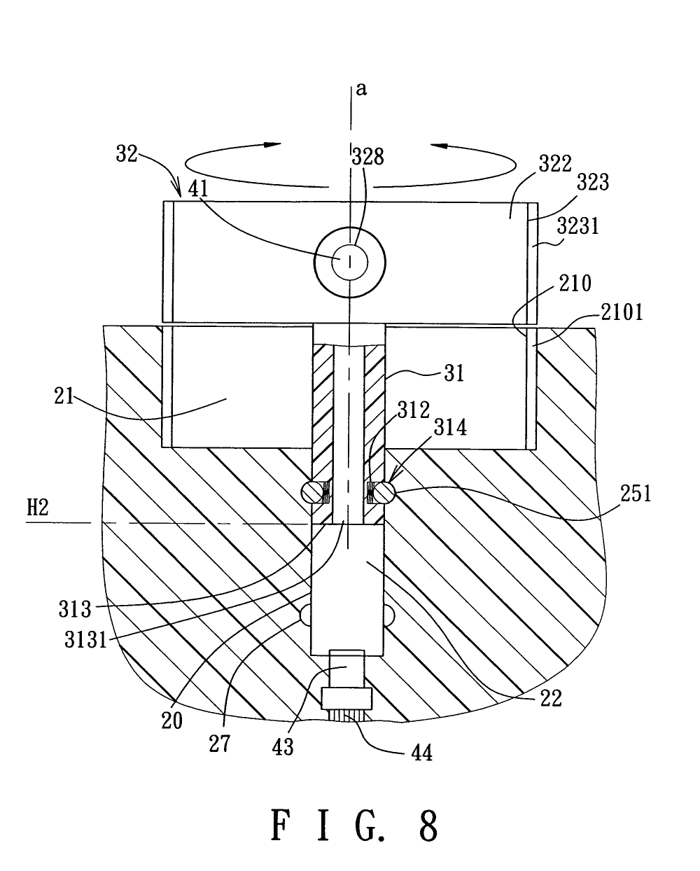

In use, the casing 3 is operable so as to move relative to the housing 200 in the longitudinal direction (A) between a retracted position, where the sleeve body 31 and the case body 32 of the casing 3 are received respectively in the inner receiving space 22 and the receiving groove 21 in the housing 200, as shown in FIG. 7, and an extended position, where a portion of the sleeve body 31 of the casing 3 is disposed outwardly of the inner receiving space 22 in the housing 200 and is disposed in the receiving groove 21 in the housing 200 and where the case body 32 of the casing 3 is disposed outwardly of the receiving groove 21 in the housing 200, as shown in FIG. 8. The casing 3 is also rotatable relative to the housing 200 about a central axis (a) of the sleeve body 21 when the casing 3 is at the extended position, as indicated by arrows of FIG. 8.

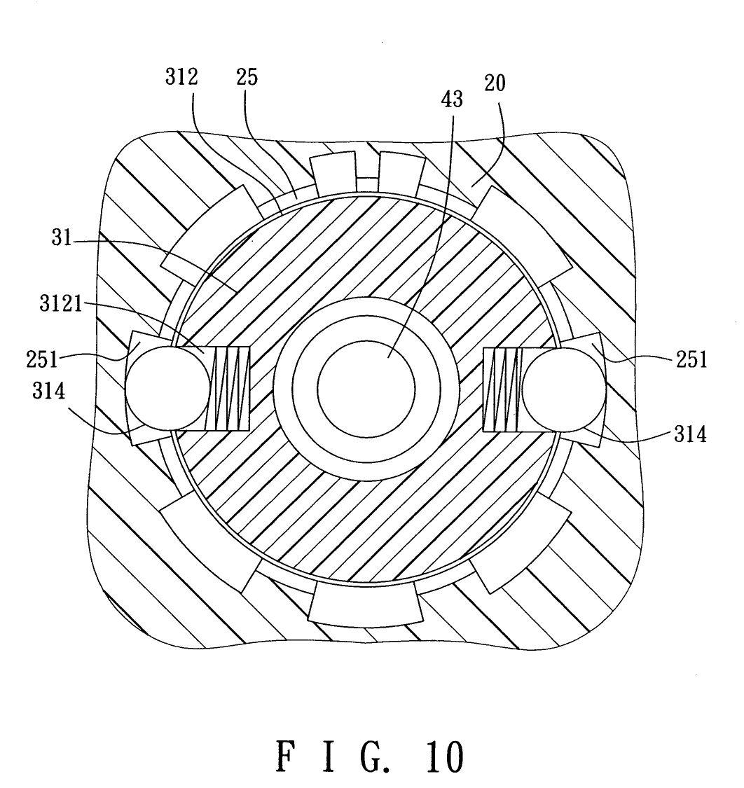

When the casing 3 is at the retracted position, the spring-loaded retainers 314 engage releasably and respectively the engaging grooves 27 in the annular inner surrounding wall 20 of the housing 200, as shown in FIG. 7. When the casing 3 is at the extended position, the spring-loaded retainers 314 engage releasably and movably the C-shaped guiding groove 25 in the annular inner surrounding wall 20 of the housing 200, and further engage releasably and respectively two selected ones of the enlarged groove portions 251 such that the casing 3 is positioned at a desired angular orientation, as shown in FIGS. 8 and 10. It is noted that, during movement of the casing 3 between the retracted and extended positions, the engaging flanges 3231 of the end walls 323 of the case body 32 engage movably and respectively the guiding slots 2101 in the lateral walls 210 of the housing 200 for preventing rotation of the casing 3 relative to the housing 200.

In sum, due to arrangement of the casing 3, the imaging lens 41 and the reflector 42, the optical image from the imaging lens 41 can be received by the image sensing module 43 by means of the reflector 42 even though the casing 3 is moved or rotated relative to the housing 200. Therefore, the imaging lens 41 of the electronic device 100 of the present invention can be moved and pivoted about the central axis (a) relative to the housing 200, thereby resulting in convenience during use. Furthermore, since the image sensing module 43 is designed to be fixed in the housing 200, the electronic device 100 of the present invention can be fabricated at relatively low costs and can be assembled in a relatively simplified procedure.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. An electronic device comprising:
a housing configured with an elongate inner receiving space extending in a longitudinal direction, and formed with a housing opening in spatial communication with said inner receiving space; and
an image capturing device disposed on said housing and including
a casing mounted partly in said inner receiving space in said housing and pivotable relative to said housing, said casing being formed with a first opening in spatial communication with said inner receiving space in said housing, and a second opening disposed outwardly of said housing,
an imaging lens mounted on said casing and covering said second opening in said casing, said imaging lens being adapted for generating an optical image of an object,
an image sensing module disposed in said inner receiving space in said housing and adjacent to said first opening in said casing for sensing the optical image generated by said imaging lens, and
a reflector disposed in said casing for reflecting the optical image from said imaging lens toward said image sensing module such that the optical image is received by said image sensing module.

2. The electronic device as claimed in claim 1, wherein:
said casing has a sleeve body disposed fittingly and rotatably in said inner receiving space in said housing and movable relative to said housing in the longitudinal direction, and a case body connected fixedly to one end of said sleeve body, disposed outwardly of said housing and provided with said reflector therein, said sleeve body being configured with a first inner space, and having the other end formed with said first opening, said case body being configured with a third opening, and a second inner space in spatial communication said first inner space through said third opening and cooperating with said first inner space so as to define an image-relaying passage, said case body being formed with said second opening in spatial communication with said second inner space; and
the optical image form said imaging lens is reflected by said reflector toward said image sensing module through said image-relaying passage.

3. The electronic device as claimed in claim 2, wherein:
said case body of said casing includes a first side wall connected integrally to said one end of said sleeve body and formed with said third opening, and a second side wall connected to and perpendicular to said first side wall, and formed with said second opening; and
said reflector of said image capturing device has an inclined reflecting surface facing toward said second and third openings.

4. The electronic device as claimed in claim 3, wherein said case body of said casing is rectangular and further includes a third side wall opposite to said first side wall in the longitudinal direction and connected to said second side wall, a fourth side wall opposite to said second side wall in a transverse direction perpendicular to the longitudinal direction and interconnecting said first and third side walls, and a mounting block interconnecting integrally said third and fourth side walls, said mounting block having an inclined mounting surface mounted fixedly with said reflector thereon.

5. The electronic device as claimed in claim 4, wherein:
said housing is formed with a receiving groove defined by opposite lateral walls, and a groove bottom wall interconnecting ends of said lateral walls and formed with said housing opening; and
said casing is operable so as to move relative to said housing in the longitudinal direction between a retracted position, where said sleeve body and said case body of said casing are received respectively in said inner receiving space and said receiving groove in said housing, and an extended position, where a portion of said sleeve body of said casing is disposed outwardly of said inner receiving space in said housing and is disposed in said receiving groove in said housing and where said case body of said casing is disposed outwardly of said receiving groove in said housing, said casing being rotatable relative to said housing about a central axis of said sleeve body when said casing is at the extended position.

6. The electronic device as claimed in claim 5, wherein:
said inner receiving space in said housing is defined by an annular inner surrounding wall, said annular inner surrounding wall being formed with a C-shaped guiding groove disposed adjacent to said groove bottom wall, and opposite engaging grooves distal from said groove bottom wall; and
said sleeve body of said casing has an annular outer surrounding surface formed with opposite receiving grooves, and two spring-loaded retainers mounted retractably and respectively in said receiving grooves in said annular outer surrounding surface of said sleeve body for engaging releasably and movably said C-shaped guiding groove in said annular inner surrounding wall of said housing when said casing is at the extended position and for engaging releasably and respectively said engaging grooves in said annular inner surrounding wall of said housing when said casing is at the retracted position.

7. The electronic device as claimed in claim 6, wherein said C-shaped guiding groove in said annular inner surrounding wall of said housing has a plurality of enlarged groove portions spaced apart from each other in a circumferential direction, said spring-loaded retainers of said sleeve body of said casing engaging respectively and releasably two selected ones of said enlarged groove portions such that said casing is positioned at a desired angular orientation when at the extended position.

8. The electronic device as claimed in claim 5, wherein:
each of said lateral walls of said housing is formed with a guiding slot extending in the longitudinal direction; and
said case body of said casing further has opposite end walls interconnecting said first, second, third and fourth side walls, each of said end walls being formed with an elongate engaging flange engaging movably said guiding slot in a corresponding one of said lateral walls of said housing for preventing rotation of said casing relative to said housing during movement of said casing between the retracted and extended positions.

9. The electronic device as claimed in claim 1, wherein said imaging lens is a convex lens.
